(19) United States
(12) Patent Application Publication
(10) Pub. No.: US 2018/0274652 A1
(43) Pub. Date: Sep. 27, 2018

(54) UREA PUMP MODULE

(71) Applicants: Hyundai Motor Company, Seoul (KR); Kia Motors Corporation, Seoul (KR); Hyundam Industrial Co., Ltd, Asan-si (KR)

(72) Inventors: Sung Won LEE, Hwaseong-si (KR); Seung Hoon CHOI, Seoul (KR); June Young PARK, Hwaseong-si (KR); Tae Yoon LEE, Seoul (KR); Yong Taek HWANG, Cheonan-si (KR); IL Kyu CHOI, Cheonan-si (KR); Chan Yo JEON, Cheonan-si (KR); Bu Hyeon CHO, Cheonan-si (KR)

(73) Assignees: Hyundai Motor Company, Seoul (KR); Kia Motors Corporation, Seoul (KR); Hyundam Industrial Co., Ltd, Asan-si (KR)

(21) Appl. No.: 15/800,310

(22) Filed: Nov. 1, 2017

(30) Foreign Application Priority Data
Mar. 27, 2017 (KR) 10-2017-0038572

(51) Int. Cl. F16H 57/00; F01N 3/20; B60K 17/00; B01D 35/26; B01D 29/11; B01D 19/00

(52) U.S. Cl. CPC F16H 57/0006; F01N 3/20; B60K 17/00; F01N 3/2896; B01D 29/114; B01D 19/0031; F01N 2610/02; B01D 35/26

(57) ABSTRACT

A urea pump module in a urea tank, which is filled with an aqueous urea solution, to supply the urea solution to an exhaust line may include: a flange device disposed to close a mounting hole formed through a bottom surface of the urea tank; a pump device having an inlet port for introduction of the urea solution and an outlet port connected to a discharge portion of the flange device, the pump device providing pumping force to discharge the urea solution from the urea tank; a first filter device coupled to an internal to the flange device to surround the pump device and serving to filter the urea solution to be introduced into the pump device; and a second filter device coupled to a top portion of the flange device to cover the pump device and serving to discharge air generated inside the pump device outward.

### CROSS-REFERENCE TO RELATED APPLICATION

The present application claims priority to Korean Patent Application No. 10-2017-0038572 filed on Mar. 27, 2017, the entire contents of which is incorporated herein for all purposes by this reference.

### BACKGROUND OF THE INVENTION

### Field of the Invention

The present invention relates to a urea pump module, and more particularly, to a urea pump module, which prevents the introduction of foreign substances into a urea pump and ensures smooth discharge of air inside a filter.

### Description of Related Art

Generally, eco-friendly vehicles are being developed worldwide, and vehicle exhaust gas emission standards in respective countries are gradually becoming more stringent.

In addition, vehicle makers are developing eco-friendly diesel vehicles due to carbon dioxide regulations. Here, the key references of exhaust gas of diesel vehicles are nitrogen oxides and particulate matter. Among these, as nitrogen oxide reduction techniques, LNT and UREA-SCR are under the spotlight.

In particular, UREA-SCR is useful for reducing nitrogen oxides discharged from a diesel engine of a large vehicle.

UREA-SCR is a selective reduction system in which harmless urea is injected into an exhaust system, and when the injected urea is converted into ammonia via thermal decomposition, nitrogen oxides are converted into harmless components such as, for example, water and nitrogen via reaction with the converted ammonia. Such a selective reduction system requires a separate storage system that stores an aqueous urea solution therein.

To this end, the aqueous urea solution storage system includes an aqueous urea solution tank, a pump, an injection port, a pipe, a wire, and various sensors. In particular, the pump is necessarily configured to stably pump urea, which is strongly basic.

In the aqueous urea solution storage system, however, the storage tank may sequentially freeze from the bottom to the top thereof when urea freezes, thus undergoing expansion in volume and greater deformation in the upper portion thereof. Therefore, when a pump module is mounted on the upper portion, there is a risk of damage to a flange due to freezing.

In addition, the pump module does not permit the replacement of a filter alone, causing an increase in repair and maintenance costs. In addition, the amount of urea that is collected is reduced due to the small filtering area of the filter.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a urea pump module, which includes an integrated filter device configured to surround both the side surface and the upper surface of the urea pump module, the filter device having a side surface configured as a wound filter and an upper surface configured as a filter formed of a highly air-permeable material configured for discharging urea and air together, enhancing the introduction speed of urea caused by the smooth discharge of air therein.

Various aspects of the present invention are directed to providing a urea pump module provided in a urea tank, which is filled with an aqueous urea solution, to supply the aqueous urea solution to an exhaust line through which exhaust gas is discharged, the urea pump module including a flange device fixed to close a mounting hole formed through a bottom surface of the urea tank, a pump device having an inlet port for introduction of the aqueous urea solution and an outlet port connected to a discharge portion formed on the flange device, the pump device providing pumping force to discharge the aqueous urea solution to an outside of the urea tank, a first filter device coupled to an internal to the flange device to surround the pump device, the first filter device serving to filter the aqueous urea solution to be introduced into the pump device, and a second filter device coupled to a top portion of the flange device and configured to cover a top portion of the pump device, the second filter device serving to discharge air generated inside the pump device outward.

In an exemplary embodiment, the flange device may include a coupling member, which is disposed upright to have the same height as the first filter device and has a plurality of through-holes formed in an external circumferential surface thereof, a plurality of fastening members being provided on an upper end portion of the coupling member, and the first filter device may be inserted to come into contact with an internal circumferential surface of the coupling member to be exposed outward through the through-holes, and is integrally or monolithically coupled to a bottom portion of the second filter device.

In another exemplary embodiment, the second filter device may have a plurality of coupling holes configured to allow the respective fastening members to vertically penetrate therethrough together, and the second filter device may be coupled to the coupling member when insert members are inserted into the fastening members protruding through the coupling holes.

In still another exemplary embodiment, the second filter device may be separable from the coupling member via selective removal of the insert members.

In yet another exemplary embodiment, the second filter device may be configured as a filter formed of a material having higher air permeability than the first filter device.

In still yet another exemplary embodiment, the urea pump module may further include an absorption device located between the second filter device and the pump device to absorb volume expansion of the aqueous urea solution occurring when the aqueous urea solution freezes.

In a further exemplary embodiment, the absorption device may be formed of water-resistant ethylene propylene diene monomer (EPDM) (M-class) rubber.

In another further exemplary embodiment, the absorption device may include a cutout member formed at a position corresponding to a fixing cover, which is assembled to the top portion of the pump device, the cutout member being configured to allow the fixing cover to be inserted thereinto.

Other aspects and exemplary embodiments of the invention are discussed infra.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and FIG. 1B are exploded perspective views illustrating the exploded state of a urea pump module according to an exemplary embodiment of the present invention;

FIG. 2 is a perspective view illustrating the coupled state of the urea pump module according to the exemplary embodiment of the present invention;

FIG. 3 is a view illustrating a second filter device fastened to the urea pump module according to the exemplary embodiment of the present invention;

FIG. 4 is a view illustrating the circulation of urea and the discharge of air with respect to the urea pump module according to the exemplary embodiment of the present invention;

FIG. 5 is a view illustrating an absorption device for the urea pump module according to the exemplary embodiment of the present invention; and

FIG. 6 is a view illustrating the state in which the absorption device is coupled to the urea pump module according to the exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the exemplary embodiments of the present invention will be described in detail with reference to the accompanying drawings to allow those skilled in the art to easily practice the present invention.

The advantages and features of the present invention and the way of attaining them will become apparent with reference to embodiments described below in detail

The present invention, however, are not limited to the embodiments disclosed hereinafter and may be embodied in many different forms. Rather, these exemplary embodiments are provided so that this disclosure will be through and complete and will fully convey the scope to those skilled in the art. The scope of the present invention may be defined by the claims.

In the following description of the present invention, a detailed description of known functions and configurations incorporated herein will be omitted when it may make the subject matter of the present invention rather unclear.

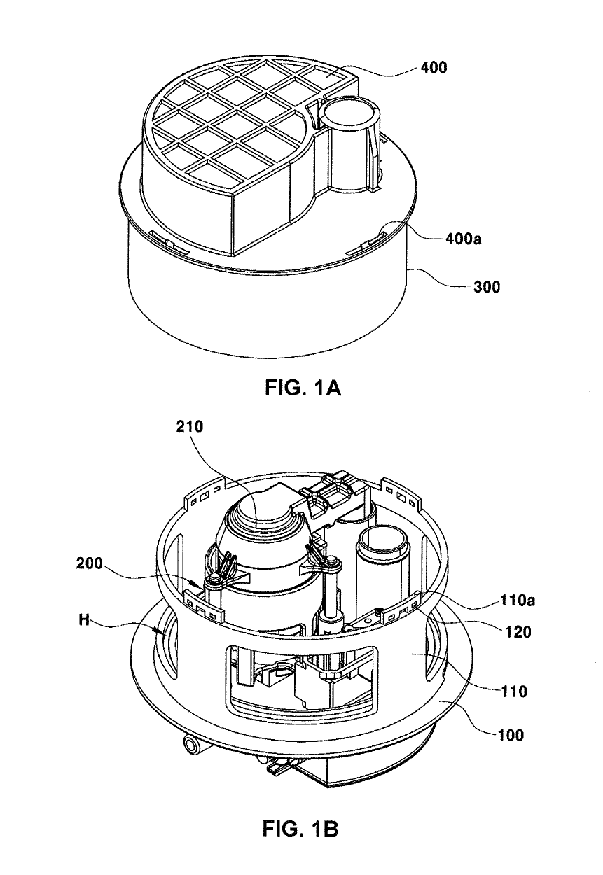

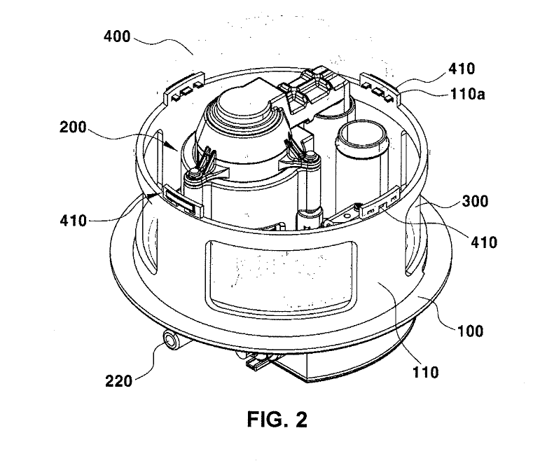

FIGS. 1A and B are exploded perspective views illustrating the exploded state of a urea pump module according to an exemplary embodiment of the present invention, and FIG. 2 is a perspective view illustrating the coupled state of the urea pump module according to the exemplary embodiment of the present invention.

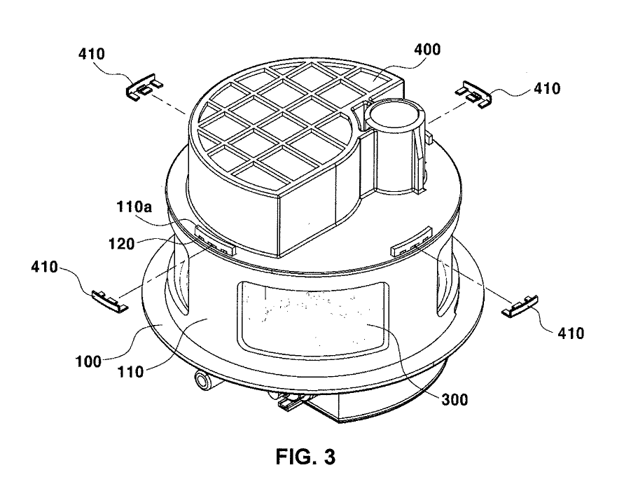

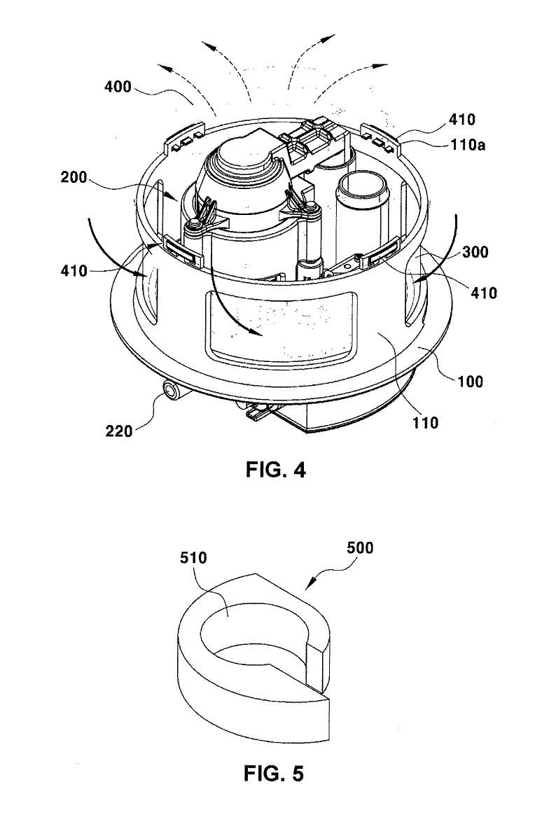

In addition, FIG. 3 is a view illustrating a second filter device fastened to the urea pump module according to the exemplary embodiment of the present invention, and FIG. 4 is a view illustrating the circulation of urea and the discharge of air with respect to the urea pump module according to the exemplary embodiment of the present invention.

As illustrated in FIGS. 1A, 1B and FIG. 2, the urea pump module is provided in a urea tank, which is filled with a given amount of aqueous urea solution and is configured to supply the aqueous urea solution, which is a reducing agent, to an exhaust line through which exhaust gas is discharged. To this end, the urea pump module according to the present embodiment includes a flange device 100, a pump device 200, a first filter device 300, and a second filter device 400.

First, the flange device 100 is fixed to close a mounting hole, which is formed through the bottom surface of the urea tank, which is filled with a given amount of aqueous urea solution, which is a reducing agent.

With the flange device 100, a body portion of the urea pump module including the pump device 200 may be disposed inside the urea tank to enable the forcible suction of aqueous urea solution by the pumping force of the pump device 200. In addition, with the flange device 100, a remaining body portion of the urea pump module is exposed to the outside of the urea tank so that the aqueous urea solution, forcibly suctioned by the pump device 200, may be injected into an exhaust pipe through an injector, which is connected to a supply line.

The flange device 100 is a plate-shaped member that comes into close contact with and is fixed to the external surface of the urea tank, with a sealing member interposed therebetween. The flange device 100 includes a discharge portion 220 formed on the lower surface thereof. The discharge portion 220 is in communication with an outlet port of the pump device 200 to discharge the forcibly suctioned aqueous urea solution to the outside of the urea tank.

The flange device 100 includes a coupling member 110, which is disposed upright to have the same height as the first filter device 300 and has a plurality of through-holes H formed in the external circumferential surface thereof. A plurality of fastening members 110a is provided on the upper end portion of the coupling member 110.

Here, the coupling member 110 has a predetermined height to surround the pump device 200 and is integrally disposed to the flange device 100. The coupling member 110 guides the installation of the first filter device 300, and allows urea to be introduced inward through the through-holes H to pass through the first filter device 300.

Meanwhile, in a urea supply system provided as a reducing agent injection system, which is provided in an engine, the urea tank is filled with an aqueous urea solution, which is a reducing agent, and the supply line, which is in communication with the discharge portion 220 of the flange device 100, provides a passage for supplying the aqueous urea solution from the urea tank to the injector.

Here, an exhaust detector and a temperature sensor, disposed on the exhaust pipe, are electrically connected to a urea controller, and the urea controller causes a predetermined amount of aqueous urea solution to be stably injected into the exhaust pipe based on signals from the exhaust detector and the temperature detector under the control of a controller. At this time, a converter in the exhaust pipe undergoes a reduction reaction by which nitrogen oxides included in exhaust gas is converted into nitrogen and water using the aqueous urea solution, which is a reducing agent, injected from the injector.

For the present reduction reaction, the pump device 200 provides pumping force to discharge the aqueous urea solution in the urea tank to the outside of the urea tank to ensure that the predetermined amount of aqueous urea solution is stably injected into the exhaust pipe as described above.

That is, the pump device 200 has an inlet port, into which the aqueous urea solution that has passed through the first filter device 300 is introduced, and the outlet port, which is in communication with the discharge portion 220 formed on the flange device 100, and provides the pumping force to discharge the aqueous urea solution to the outside of the urea tank.

The above-described structure of the pump device 200 is the same as the structure of a known urea pump, and thus a detailed description related to the structure will be omitted in the present embodiment.

The first filter device 300 may be coupled to the coupling member 110, which is disposed upright on the flange device 100, to surround the pump device 200. In a process of the pump device 200 pumping the aqueous urea solution in the urea tank to discharge the aqueous urea solution to the outside of the urea tank, the first filter device 300 may filter the aqueous urea solution to be introduced into the pump device 200, removing foreign substances therefrom.

In other words, the first filter device 300 is configured as a hollow cylinder that surrounds the pump device 200 with a predetermined distance therebetween. Accordingly, when the pump device 200 operates to forcibly suction the aqueous urea solution in the urea tank through the inlet port thereof, the aqueous urea solution may be filtered to remove foreign substances therefrom while passing through the first filter device 300.

In the state in which the first filter device 300 is inserted to come into contact with the internal circumferential surface of the coupling member 110, the first filter device 300 is exposed outward through the through-holes H having a predetermined size, which may increase the resultant filtering area compared to the structure of the related art.

The first filter device 300 is integrally coupled to the bottom portion of the second filter device 400, which has the same shape as the first filter device 300, more, a cylindrical shape.

Accordingly, since the first filter device 300 may be introduced into the coupling member 110 when the second filter device 400 is vertically coupled thereto, the first filter device 300 may be coupled to the coupling member 110 simultaneously with the coupling of the second filter device 400.

Here, the first filter device 300 may be configured as a wound filter, which prevents the introduction of foreign substances thereinto and has excellent filter rigidity, thus undergoing less variation in shape due to external shocks or load.

The second filter device 400 is coupled to the top portion of the flange device 100, more specifically, the coupling member 110, and is configured to cover the top portion of the pump device 200. The second filter device 400 is provided to discharge air generated inside the pump device 200 outward.

The second filter device 400 is configured as a filter formed of a material having higher air permeability than the first filter device 300. The present is configured to ensure the effective discharge of air inside the pump device 200.

Meanwhile, the second filter device 400 has a plurality of coupling holes 400a, and the coupling holes 400a are formed to enable penetration of the fastening members 110a of the coupling member 110 therethrough.

That is, as illustrated in FIG. 3, each fastening member 110a penetrates a corresponding one of the coupling holes 400a to protrude therefrom such that a plurality of fastening holes 120 formed in the fastening member 110a is exposed outward, and an insert member 410 is inserted into the fastening member 110a, whereby the second filter device 400 may be fastened to the coupling member 110.

The fastening members 110a may protrude from four locations, and correspondingly, four insert members 410 may be provided to be inserted into the fastening members 110a, which protrudes through the respective coupling holes 400a, to prevent the second filter device 400 from being unintentionally separated from the coupling member 110.

The second filter device 400 may be easily separated, along with the first filter device 300, from the coupling member 110 via selective removal of the insert members 410. Thus, the first filter device 300 and the second filter device 400 are configured for being individually serviced, which may prevent an increase in repair and maintenance costs.

The second filter device 400 may be formed of a non-woven fabric material having excellent air permeability. When such a non-woven fabric is evenly disposed on the upper surface of the second filter device 400 to secure the smooth discharge of air inside the pump device 200, the introduction speed of urea through the first filter device 300 may be enhanced.

In conclusion, when the pump device 200 operates to cause urea to be introduced thereinto by passing through the first filter device 300, as illustrated in FIG. 4, the second filter device 400 causes the air therein to be discharged outward through the non-woven fabric of the upper surface thereof. Accordingly, the second filter device 400 may allow warm air, which is generated therein due to continuous operation of the pump device 200 and high external temperatures, to be smoothly discharged outward.

In the present way, the second filter device 400 realizes effective heat exchange of urea between the inside and the outside thereof, achieving a structure that is advantageous for heat radiation.

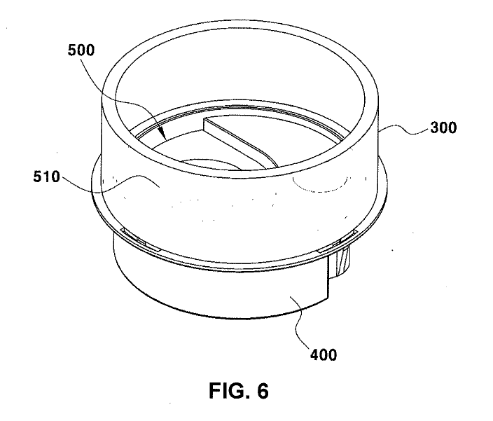

FIG. 5 is a view illustrating an absorption device in the urea pump module according to the exemplary embodiment of the present invention, and FIG. 6 is a view illustrating the state in which the absorption device is coupled to the urea pump module according to the exemplary embodiment of the present invention.

As illustrated in FIG. 5, the urea pump module according to the present embodiment further includes an absorption device 500, which is disposed between the second filter device 400 and the pump device 200 and is configured to absorb the volume expansion of aqueous urea solution generated when the aqueous urea solution freezes.

Generally, the aqueous urea solution in the urea tank is colorless, odorless, non-toxic, non-flammable, and strongly basic (pH 10 or more), and is mixed with water at a ratio of 32.5%. The freezing point of the strongly basic aqueous urea solution is −11.5 degrees Celsius, and the volume thereof may expand about 5% to 11% at the freezing point.

Thus, in winter when the ambient temperature drops below zero, internal stress is generated in the filter as the volume of urea expands about 7%. To eliminate the internal stress caused by the expansion of urea, the absorption device 500 may be disposed inside the filter.

The absorption device 500 may be formed of water-resistant ethylene propylene diene monomer (EPDM) (M-class) rubber, to absorb the stress generated upon volume expansion caused by the freezing of the aqueous urea solution in the urea tank or the filter, and to prevent damage to constituent elements of the pump module due to the stress.

Here, the absorption device 500 has a cutout member 510, and the cutout member 510 is provided at the position corresponding to a fixing cover 210, which is assembled to the top portion of the pump device 200. The cutout member 510 is formed in a recess shape so that the fixing cover 210 is inserted into the cutout member 510, being configured to surround the external circumferential surface of the pump device 200.

Accordingly, the absorption device 500, which includes the cutout member 510 to correspond to the structure of the pump device 200, may effectively are configured to eliminate the stress inside the filter.

As is apparent from the above description, according to an exemplary embodiment of the present invention, through the provision of an integrated filter device, which is configured to surround both the side surface and the upper surface of a urea pump module, and which includes a side surface configured as a wound filter and an upper surface configured as a filter formed of a highly air-permeable material configured for discharging urea and air together, it is possible to enhance the introduction speed of urea caused by the smooth discharge of air inside the filter device.

In addition, according to an exemplary embodiment of the present invention, since warm air, which is generated inside the filter device due to continuous operation of a pump device and high external temperatures, may be smoothly discharged outward, the filter device realizes effective heat exchange of urea between the inside and the outside thereof, exhibiting a structure that is advantageous for heat radiation.

In addition, according to an exemplary embodiment of the present invention, the filter device may be easily separated from a flange device via the selective removal of insert members. This enables each filter to be individually serviced, preventing an increase in repair and maintenance costs for the urea filter module.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission mount for a vehicle, comprising:
a bracket which accommodates an insulator having an external core coupled with an internal core, and includes an upper housing that covers an upper portion of the insulator, and a plate that supports a lower portion of the insulator; and
the external core which includes, based on the inserted internal core, a lower portion, an upper portion, both lateral portions, both bridge portions that support a body of the external core, and a lower main stopper formed on an upper surface of the plate,
wherein a space portion is formed in a body of the external core wherein a strut, which protrudes from a rear surface of an upper housing of the bracket, is configured to be inserted into the space portion, and internal wall surfaces of the space portion contact with an upper portion, a lower portion, and a front portion of the strut, respectively.

2. The transmission mount of claim 1, wherein the upper housing includes an upper surface which covers the upper portion of the insulator, a rear surface which covers a rear surface of the insulator, and lateral surfaces which cover left and right surfaces of the insulator, respectively.

3. The transmission mount of claim 1, wherein a lower auxiliary stopper is formed to protrude upward from an upper surface of the lower portion of the external core.

4. The transmission mount of claim 1, wherein an upper auxiliary stopper is formed to protrude downward from a bottom surface of the upper portion of the external core.

5. The transmission mount of claim 1, wherein lateral auxiliary stoppers are formed in a direction toward a center from internal walls of the lateral portions of the external core.

6. The transmission mount of claim 1, wherein an internal wall surface auxiliary stopper is formed toward an end surface of the strut from an internal wall surface of the space portion formed in the external core which faces the end surface of the strut.
